(19) United States
(12) Patent Application Publication
(10) Pub. No.: US 2026/0015930 A1
(43) Pub. Date: Jan. 15, 2026

(54) SYSTEM AND METHOD FOR GENERATING CONTIGENCY PLANS FOR HYDROCARBON NETWORK MANAGEMENT

(71) Applicant: SAUDI ARABIAN OIL COMPANY, Dhahran (SA)

(72) Inventors: Bader A. SAMARI, Dhahran (SA); Yasser A. ALSHAALAN, Dhahran (SA); Esam T. KHARBAT, Dhahran (SA); Abdullah A. BANIHUMAIM, Dhahran (SA); Neil A. FAIRWEATHER, Dhahran (SA)

(73) Assignee: SAUDI ARABIAN OIL COMPANY, Dhahran (SA)

(21) Appl. No.: 18/771,504

(22) Filed: Jul. 12, 2024

(51) Int. Cl. E21B 44/00; G06Q 30/0202

(52) U.S. Cl. CPC E21B 44/00; G06Q 30/0202; E21B 2200/20; E21B 2200/22

(57) ABSTRACT

Systems and methods are disclosed for generating contingency plans for managing a hydrocarbon network. A hydrocarbon network model representative of the hydrocarbon network that can include one or more plants can be generated, and simulated to predict hydrocarbon demand, production, and potential disruptions for the hydrocarbon network. One or more contingency plans for responding to one or more disruptions in the hydrocarbon network model can be generated based on the predicted hydrocarbon demand, production, and potential disruptions, and a plant readiness of the one or more plants. The one or more contingency plans can be stored a contingency plan database, and one of the or more contingency plans can be retrieved from the contingency plan database based on a contingency plan request. The contingency plan request can identify a disruption in the hydrocarbon network. The retrieved contingency plan can be output to respond to the disruption in the hydrocarbon network.

### FIELD OF THE DISCLOSURE

This disclosure relates generally to hydrocarbon production, and more particularly, to a system and method for generating contingency plans for managing a hydrocarbon network.

### BACKGROUND OF THE DISCLOSURE

A hydrocarbon network (or hydrocarbon supply chain) encompasses facilities, infrastructure, and/or operations that are involved in exploration, extraction, processing, transportation, and/or distribution of hydrocarbons. A hydrocarbon network can include several different distribution networks, such as crude oil network, a gas network, a natural gas liquid (NGL) network, and refining and distribution networks. The hydrocarbon network can include upstream and downstream processing facilities. Upstream facilities are facilities involved in exploration and/or production operations, such as oil and gas extraction (e.g., oil platforms, gas processing plants, separation units, etc.). Downstream facilities are facilities involved in refining crude oil and/or processing raw natural gas into usable products (e.g., refineries, petrochemical plants, and distribution networks that deliver products to consumers).

Hydrocarbon networks can experience drops in hydrocarbon production, such as from an upset or interruption. An upset in a hydrocarbon network refers to an unexpected disruption and/or malfunction that causes operations in the hydrocarbon network to deviate from normal conditions. This can include equipment failure, process deviations, and/or other operational anomalies that affect a performance and stability of the hydrocarbon network. For example, if a pump in a crude oil pipeline fails this can cause a reduction in a flow rate of oil being transported. This failure disrupts the hydrocarbon network, which can lead to delays in delivery and potentially causing a backlog of crude oil at an extraction site. An interruption in a hydrocarbon network refers to a temporary halt or stoppage of operations due to external and/or internal factors. The factors can include planned activities, such as maintenance activities, or unplanned, such as natural disasters, accidents, and/or other unforeseen events that stop or impact a normal flow of hydrocarbons.

When an upset or interruption occurs, one or more contingency measures are activated to redirect production to alternative facilities and/or manage existing inventories to ensure that operations continue with minimal interruption. For instance, if a refinery experiences a sudden shutdown due to a mechanical failure, the one or more contingency measures can be implemented that involve increasing output at another refinery or tapping into stored reserves in the hydrocarbon network to maintain supply levels. In a short term, these measures can bridge a gap caused by the disruption, ensuring that immediate needs of customers and/or markets are met. However, if the upset or interruption persists or if the one or more contingency measures are inadequate, alternative facilities can become strained, which can lead to overutilization, maintenance issues, and/or even failures at those locations. Additionally, reliance on stored reserves can deplete strategic inventories, leaving the hydrocarbon network vulnerable to further disruptions.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

According to an embodiment, a method can include generating a hydrocarbon network model representative of a hydrocarbon network comprising one or more plants, simulating the hydrocarbon network model to predict hydrocarbon demand, production, and potential disruptions for the hydrocarbon network, generating one or more contingency plans for responding to one or more disruptions in the hydrocarbon network model based on the predicted hydrocarbon demand, production, and potential disruptions, and a plant readiness of each of the one or more plants, storing the generated one or more contingency plans in a contingency plan database, retrieving one of the or more contingency plans from the contingency plan database in response to a contingency plan request, the contingency plan request identifying a disruption in the hydrocarbon network, and outputting the retrieved contingency plan to respond to the disruption in the hydrocarbon network.

In another embodiment, a system can include memory to store machine-readable instructions, and one or more processors to access the memory and execute the machine-readable instructions. The machine-readable instructions can include a simulation system configured to simulate a hydrocarbon network model to predict hydrocarbon demand, production, and potential disruptions for a hydrocarbon network comprising one or more plants and a contingency plan engine configured to generate one or more contingency plans for responding to one or more disruptions in the hydrocarbon network model based on the predicted hydrocarbon demand, production, and potential disruptions, a plant readiness of each of the one or more plants, and switchover difficulty adjustment (SDA) data. The SDA data can indicate a difficulty of switching operations from a first plant to a second plant of the one or more plants for responding to one or more disruptions in the hydrocarbon network model. The contingency plan engine is further configured to identify one of the more contingency plans for responding to a disruption in the hydrocarbon network, and output the identified contingency plan to a device to respond to the disruption in the hydrogen carbon network.

According to another embodiment, a system can include one or more computing platforms configured to: generate a hydrocarbon network model representative of a hydrocarbon network comprising one or more plants, simulate the hydrocarbon network model to predict hydrocarbon demand, production, and potential disruptions for the hydrocarbon network, generate one or more contingency plans for responding to one or more disruptions in the hydrocarbon network model based on the predicted hydrocarbon demand, production, and potential disruptions, and a plant readiness of each of the one or more plants, store the generated one or more contingency plans in a contingency plan database, retrieve one of the or more contingency plans from the contingency plan database in response to a contingency plan request, the contingency plan request identifying a disruption in the hydrogen carbon network, and output the retrieved contingency plan to respond to the disruption in the hydrogen carbon network.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an example of a tool that can be used to provide a contingency plan.

FIG. 2 is an example of an interactive graphical user interface (GUI).

FIGS. 3-4 is an example of a schematic diagram of a hydrocarbon network.

FIG. 5 is an example of a micro system that can be used at a facility of a hydrocarbon network.

FIG. 6 is an example of another micro system that can be used at a facility of a hydrocarbon network.

FIG. 7 is an example of a method for generating a contingency plan.

FIG. 8 is an example of a computing environment that can be used to perform one or more methods according to an aspect of the present disclosure.

FIG. 9 is an example of a cloud computing environment that can be used to perform one or more methods according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Existing approaches for responding to an upset or interruption in a hydrocarbon network rely on using pre-defined contingency plans (or contingency measures). Contingency plans are developed based on risk assessments and include various scenarios that could cause production disruptions, such as equipment failures, natural disasters, and/or supply chain interruptions. To create (or formulate) a contingency plan, forecasts are made to predict potential disruptions in the hydrocarbon network and determine which plans (or facilities) are ready to take over production, if needed. Computational models can be used to predict future scenarios based on various input parameters and assumptions to simulate potential disruptions in the hydrocarbon network and forecast an impact of the potential disruptions on production, distribution, and/or overall operations of the hydrocarbon network. Simulations rely on static data and assumptions that may not accurately reflect real-time conditions of the hydrocarbon network, and thus can lead to insufficient contingency plans, or deficient contingency plans.

Furthermore, existing contingency plant generation methodologies and systems do not factor in (or consider) switchover difficulties and individual plant readiness. Switchover difficulties refers to challenges and/or complications that arise when shifting production, processing, and/or distribution activities from one facility (or equipment) to another. Such difficulty, for example, can include technical, operational, and/or logistical issues that need to be managed to ensure a smooth and efficient transition of hydrocarbon products (e.g., oil, gas, and/or water, etc.). Individual plant readiness refers to a state of preparedness of a specific facility within the hydrocarbon network to take on additional production capacity or to handle a switchover in operations. This can include, for example, a plant's ability to operate efficiently and safely under new conditions, considering factors such as equipment condition, maintenance schedules, workforce availability, and/or real-time operational parameters. Moreover, because existing contingency plans generation methodologies and systems rely on static data, such systems and methods fail to consider real-time processing parameters, such as flow rates and pressure readings, which is needed to ensure a safe and/or reliable switchover between one facility (or plant) and another in the hydrocarbon network. A switchover refers to the process of shifting production, processing, or distribution activities from one facility or (equipment) to another.

Additionally, existing contingency plant generation methodologies and systems are inaccurate and prone to human error (in contingency plan implementation) and time delays because of the static data and using predefined scenarios, which do not accurately reflect conditions and complexities of the hydrocarbon network in real-time (or substantially real-time). For example, operators are required to interpret and implement these contingency plans manually. This process is susceptible to mistakes, especially under a pressure of an ongoing disruption. Errors in judgment or execution can exacerbate a problem rather than resolve it. Moreover, identifying a best course of action during a disruption takes time, particularly when relying on static plans that may not fit specific circumstances. Delays in decision-making and implementation can result in prolonged downtime and in some instances in-danger human life, or other equipment and/or facilities.

A tool is disclosed herein that can be used to generate one or more contingency plans for responding to a disruption in a hydrocarbon network in real-time (or substantially real-time). Example disruptions can include, but not limited to, an upset or interruption, as disclosed herein herein, however, other types of disruptions are contemplated with the scope of the present disclosure. The tool can be used to assist operators, in some instances, identify a best course of action (the contingency plan) for responding to a disruption in hydrocarbon network production.

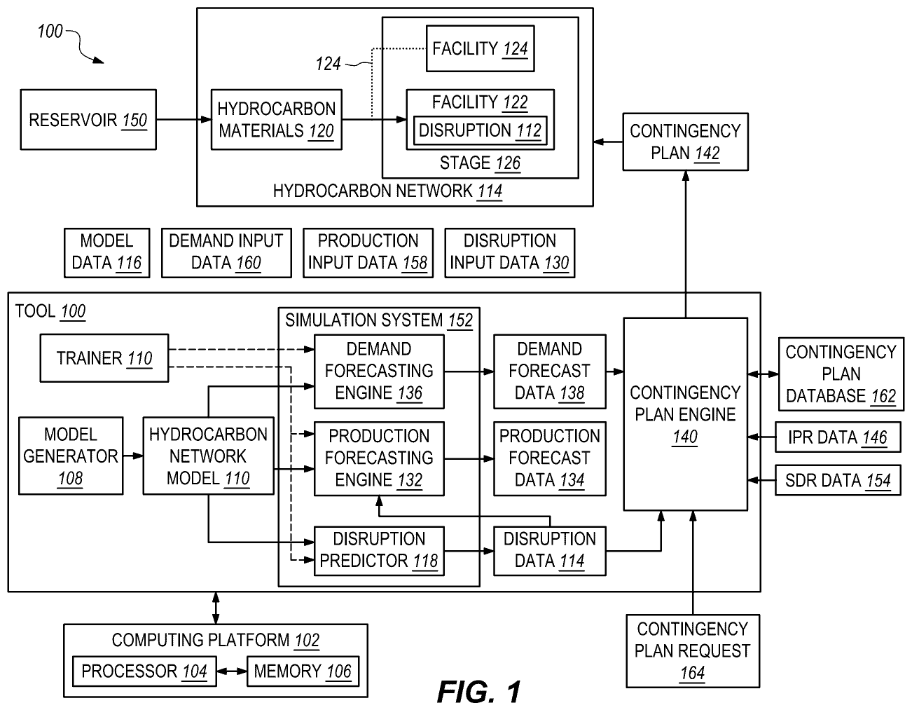

FIG. 1 is an example of a tool 100 that can be used to provide a contingency plan 142. The contingency plan 142 can be used for responding to a disruption 112 in a hydrocarbon network 114. The hydrocarbon network 114 can include stages with different facilities and/or equipment for exploration, production, transportation, refining, and/or distribution of hydrocarbons. FIG. 1 illustrates an example of one of the stages, identified with reference numeral 126. Stage 126 can include one or more facilities, such as a facility 122 and a facility 124. The contingency plan 142 can be used for coordinating, implementing and/or facilitating a switchover, for example, shifting production, processing, and/or distribution activities relating to a hydrocarbon materials 120 from the facility 122 (or equipment at the facility 122) to the facility 124. In the example of FIG. 1, switchover from the facility 122 to the facility 124 is shown with a dashed-line and identified with reference numeral 124. While the example of FIG. 1 illustrates the facility 122 and the facility 124 as being part of a same stage, in other examples, the facility 122 and facility 124 can be part of different stages of a hydrocarbon supply chain (the hydrocarbon network 114). The facilities 122 and 124 can correspond to plants.

The term “hydrocarbon materials” as used herein refers to both hydrocarbons found in natural resources and the refined or processed products derived from these hydrocarbons, depending on the stage of the hydrocarbon network 114. For instance, in an exploration stage, the hydrocarbon materials 120 can refer to oil or gas (e.g., crude oil or natural gas) extracted from a reservoir 150, whereas in a refining stage, the hydrocarbon materials 120 can refer to gasoline, diesel, and/or other petrochemicals produced from the oil. The reservoir 150 can be a subsurface pool of hydrocarbons contained in porous or fractured rock formations. The reservoir 150 can include geological structures that trap hydrocarbons, such as sandstone or limestone formations, and fluids (oil, gas, and/or water) contained within those rock structures.

The tool 100 can be implemented using one or more modules, shown in block form in FIG. 1. The one or more modules can be in software or hardware form, or a combination thereof. In some examples, the tool 100 can be implemented as machine readable instructions for execution on a computing platform 102, as shown in FIG. 1. The computing platform 102 can include one or more computing devices selected from, for example, a desktop computer, a server, a controller, a blade, a mobile phone, a tablet, a laptop, a personal digital assistant (PDA), and the like. The computing platform 102 can include a processor 104 and a memory 106. By way of example, the memory 106 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 104 can be implemented, for example, as one or more processor cores. The memory 106 can store machine-readable instructions (e.g., the tool 100) that can be retrieved and executed by the processor 104. Each of the processor 104 and the memory 106 can be implemented on a similar or a different computing platform. The computing platform 102 can be implemented in a cloud computing environment (for example, as disclosed herein) and thus on a cloud infrastructure. In such a situation, features of the computing platform 102 can be representative of a single instance of hardware or multiple instances of hardware executing across the multiple of instances (e.g., distributed) of hardware (e.g., computers, routers, memory, processors, or a combination thereof). Alternatively, the computing platform 102 can be implemented on a single dedicated server or workstation. In some examples, the tool 100 can be implemented as part of or integrated into software or application but in other instances, can be implemented as a stand-alone application/software (e.g., and can be invoked by software, a program, a routine, in other instances, invoked by a user).

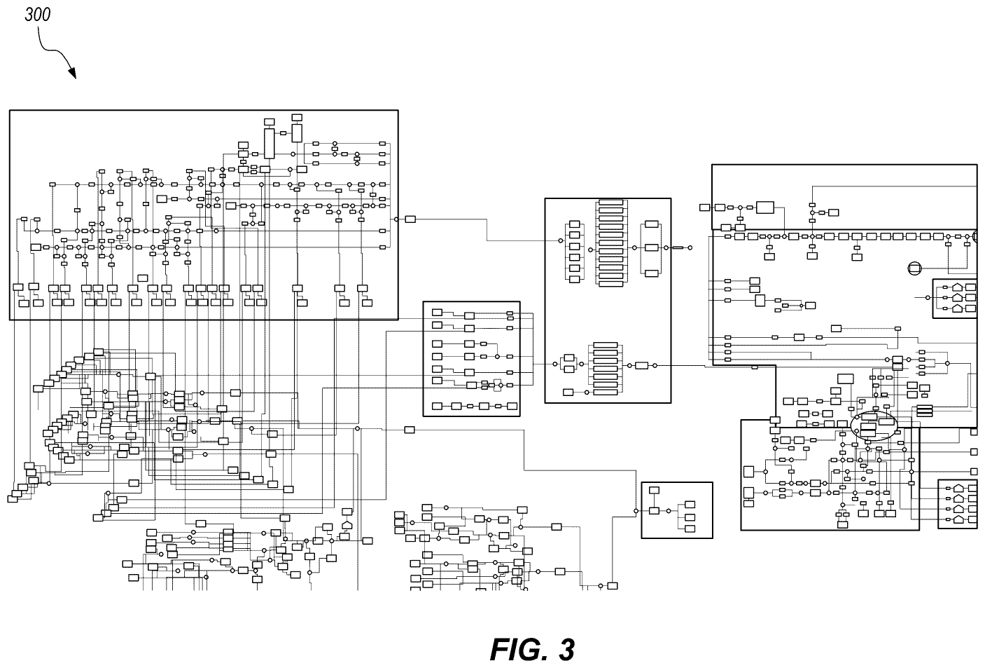

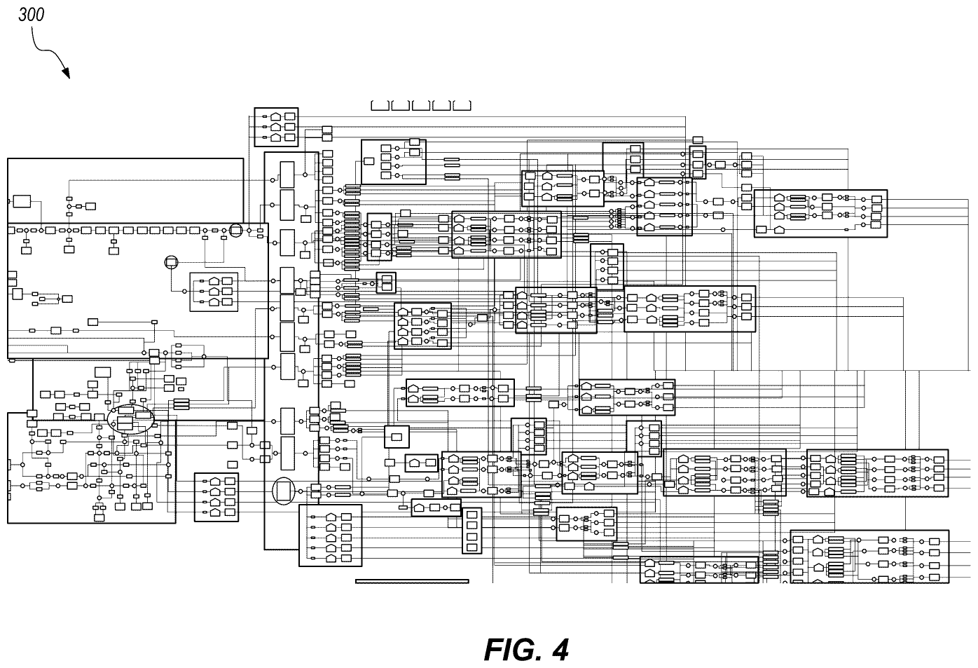

The tool 100 can include a model generator 108 that can generate a hydrocarbon network model 110. The hydrocarbon network model 110 can represent the hydrocarbon network 114. As disclosed herein, the hydrocarbon network model 110 can be used to identify one or more potential issues, such as the disruption 112 that can occur within the hydrocarbon network 114. FIGS. 3-4 is an example of a schematic diagram 300 of the hydrocarbon network 114, as shown in FIG. 1. Thus, reference can be made to one or more examples of FIGS. 3-4 in the example of FIG. 1. As disclosed herein, the model data 116 can be processed to generate the hydrocarbon network model 110, which can be a mathematical representation of the hydrocarbon network 114 used for simulation and analysis. Therefore, the schematic diagram 300 is a visual representation of the layout and components of the hydrocarbon network 114.

To generate the hydrocarbon network model 110, the model generator 108 can use model data 116, which can include facility data, pipeline network data, production data, operational data, interlink and interdependency data, logistical and supply chain data, real-time monitoring data, geospatial and environmental data, risk assessment and contingency plan data, and/or regulatory and compliance data.

The facility data can include information on different types of facilities within the hydrocarbon network 114, such as extraction sites, processing plants, refineries, storage units, distribution centers, etc. The facility data can include facility information for each facility, for example, capacity, operational parameters, and/or equipment details. The pipeline network data can include geographic and schematic data of pipeline routes connecting various facilities, and/or details about pipelines, such as diameter, length, material, pressure ratings and/or flow capacity. The production data can include information on sources of hydrocarbons, including types (e.g., crude oil, natural gas, NGLs) and/or production rates, and/or processing data, such as processing methods and capacities at various facilities, including batch processing details. The operational data can include real-time and/or historical data on operations of the facilities and pipelines, including flow rates, pressures, temperatures, and/or throughput. The operational data can include information on scheduled maintenance and/or historical maintenance activities for each facility and pipeline. The interlink and interdependency data can include information on how different hydrocarbon products and/or processes are interconnected within the hydrocarbon network 114, and/or data on the batch processing schedules and methods, for example which products are processed together and/or how they are managed within shared infrastructure. The logistics and supply chain data can include information about the hydrocarbon network 114, for example, transportation methods (e.g., pipelines, trucks, ships), storage locations, and/or distribution centers, and/or information on the supply chain logistics, including inventory levels, delivery schedules, and demand forecasts. The real-time monitoring data can include real-time data from sensors installed at various points in the hydrocarbon network 114, monitoring parameters like pressure, temperature, flow rates, and/or equipment status. The real-time monitoring data can include control systems data, for example, information from control systems that manage and automate operations of facilities and pipelines. The geospatial data can include geographic information system (GIS) information and/or mappings of physical locations and layout of facilities and/or pipelines. The environmental data can include information on environmental conditions and potential impacts, such as weather data, natural disaster risks, and/or environmental regulations. The risk assessment data can include information for risk assessments identifying potential hazards and/or vulnerabilities within the hydrocarbon network 114. The regulatory and compliance data can include information on regulatory requirements and/or compliance standards that must be met by the hydrocarbon network 114 and data on past inspections, audits, and/or compliance records.

In some examples, the facility 122 and/or the facility 124 is a processing facility. A processing facility can use same or similar equipment to process various products (e.g., the hydrocarbon materials 120). Thus in some instances, different products in the hydrocarbon network 114 can flow through shared pipelines or use common machinery at one or more stages of processing. In some examples, the processing facility can operate in batches, processing discrete quantities of different products, rather than a continuous flow. Accordingly, the hydrocarbon network model 110 can represent an infrastructure (e.g., of the processing facility) that can be shared for different hydrocarbon products, flowing together but being managed in separate batches or phases.

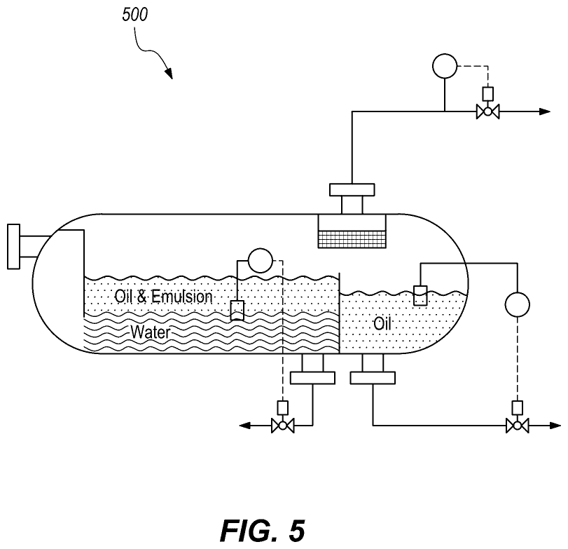

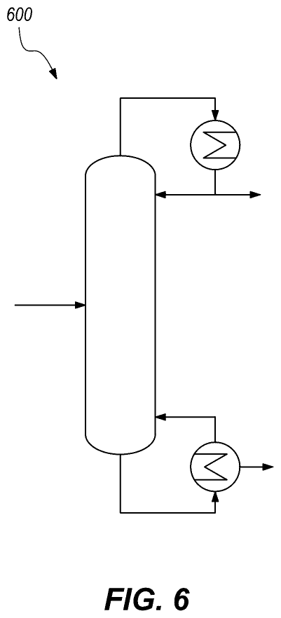

The hydrocarbon network model 110 can represent one or more facilities, such as the processing facility, at a macro- and micro-level. Macro-level refers to high-level, large-scale operations within a facility (e.g., the processing facility). Macro-level operations can include an overall flow of different products through shared pipelines and equipment. Micro-level refers to a detailed, small-scale operation within the facility (e.g., the processing facility). Micro-level operations can include specific equipment like high-pressure production traps, phase separators, and distillation columns. Thus, the hydrocarbon network model 110 can represent multiple layers of operations, macro- and micro-level operations of the hydrocarbon network 114. For example, the hydrocarbon network model 110 can represent high-level processes, such as an overall flow of hydrocarbons through pipelines and processing routes and represent detailed operations, focusing on specific equipment being used in the hydrocarbon network 114. The hydrocarbon network model 110 can include vertical layers, each layer representing a hierarchical level of operations within the hydrocarbon network 114. Each layer of the vertical layers can represent a different level of detail and operation, from broad system-wide processes (e.g., macro level) to specific equipment and functions (e.g., micro level). Accordingly, the hydrocarbon network model 110 can account for both macro-level operations (e.g., high-level flow of hydrocarbons through shared pipelines and equipment) and micro-level operations (e.g., detailed operations within facilities, such as specific equipment used). FIG. 5 is an example of a micro system 500 that can be used at a facility, such as the facility 122, as shown in FIG. 1. FIG. 6 is an example of another micro system 600 that can be used at a facility, such as the facility 122, as shown in FIG. 1. Thus, reference can be made to one or more examples of FIGS. 5-6 in the example of FIG. 1. As disclosed herein, the model generator 108 can provide the hydrocarbon network model 110 with a representation of the micro system 500 and thus consider the micro-system 500 and 600 at a micro-level.

In some examples, the tool 100 includes a simulation system 152 to simulate the hydrocarbon network model 110 to predict hydrocarbon demand, production, and potential disruptions for the hydrocarbon network 114. The simulation system 152 can utilize pre-written code to read input parameters from a data source (e.g., a customized Excel file). The input parameters include pipeline maximum capacity, normal flow values, plant (facility) maximum sustainable capacity, downstream pipeline capacity, associated storage areas/tanks, their locations within the hydrocarbon network 114, maximum pumping capacity, etc. The simulation system 152 can apply the input parameters during one or more simulations to appropriate pipelines and/or facilities within the hydrocarbon network model 110 as the model is simulated.

In some examples, the simulation system 152 includes a disruption predictor 118 to predict one or more different types of disruptions that can occur in the hydrocarbon network 114, such as the disruption 112, as shown in FIG. 1. The disruption predictor 118 can use the hydrocarbon network model 110 and disruption input data 130 to simulate different types of disruptions at the hydrocarbon network 114 to provide disruption data 144. The disruption predictor 118 can use machine learning (ML) techniques to simulate the hydrocarbon network 114 under different production scenarios to provide the disruption data 144. The disruption input data 130 can include historical disruption data, monitoring data (e.g., sensor data providing real-time information on operational parameters such as pressure, temperature, flow rates, and/or equipment status), operational data (e.g., data on current and historical operations of facilities and pipelines, including flow rates, pressures, temperatures, throughput, maintenance schedules, and/or historical maintenance activities), and/or environmental data (e.g., information on environmental conditions, such as weather forecasts, natural disaster risks, and/or environmental regulations).

The disruption data 144 can represent potential disruptions of the hydrocarbon network 114. The disruption data 144 can include information on a type of disruption, and a nature of the disruption, such as equipment failure, natural disaster, regulatory change, and/or geopolitical event. In some examples, the disruption data 144 can specify a location in the hydrocarbon network 114 where the predicted disruption can occur. An impact of the disruption on operations of the hydrocarbon network 114 can be estimated by the disruption predictor 118, including effects on production capacity, supply chain, and/or logistics and provided as part of the disruption data 144. The disruption data 144 can include a probability value indicative of a likelihood that the disruption occurs and a severity of the disruption, which can range from minor operational hiccups to major network-wide failures.

The disruption predictor 118 can be implemented as a trained machine learning (ML) model that can be provided by training a ML algorithm. The ML algorithm can be trained using a trainer 156. The trainer 156 can receive disruption training data, which can include historical disruption data, monitoring data, operational data, and/or environmental data. In some examples, the ML algorithm is a random forest, a gradient boost machine, or a neural network. The disruption training data can be split by the trainer 156 into training, validation, and test datasets. Supervised learning ML algorithms can be trained on the disruption training data, and techniques like cross-validation can be used to fine-tune the ML algorithm to provide the disruption predictor 118.

In some examples, the tool 100 includes a production forecasting engine 132 for production forecasting. The production forecasting engine 132 can be used to predict (or provide an estimate of) future hydrocarbon output across one or more stages of the hydrocarbon network 114. The production forecasting engine 132 can use ML techniques to simulate the hydrocarbon network 114 under different production scenarios to provide production forecast data 134. For example, the production forecasting engine 132 can simulate different production scenarios using the hydrocarbon network model 110, production input data 158, and in some instances, the disruption data 144, to provide the production forecast data 134. The production input data 158 can include historical production volumes (daily, monthly, and yearly volumes of different hydrocarbon types like crude oil, natural gas, and/or NGLs), operational parameters, such as flow rates, pressures, and/or temperatures, equipment operational data, and processing capacities and efficiencies across various facilities, schedule and unscheduled maintenance records to account for equipment downtime and performance, external factors, such as market demand trends, regulatory changes, geopolitical events, and/or environmental conditions, such as weather data and natural disaster risks, logistical and supply chain data, such as inventory levels, transportation method and routes, distribution center capacities, and delivery schedules, disruption data identifying equipment failures, maintenance shutdowns, natural disasters, regulatory changes, and/or geopolitical events.

The production forecasting engine 132 can analyze various production scenarios of the hydrocarbon network model 110 using the production input data 158. In some examples, the production forecasting engine 132 can use the disruption data 144 to analyze various potential disruptions such as equipment failures, maintenance shutdowns, natural disasters, regulatory changes, and/or geopolitical events that could impact production capacity and supply chain operations. For example, the production forecasting engine 132 can analyze an impact of a forecasted equipment failure at a refinery (e.g., the facility 122, as shown in FIG. 1). Thus, the production forecasting engine 132 can simulate different scenarios, such as equipment being offline for maintenance or due to a catastrophic failure, and assess how this would affect a refinery's capacity to process oil, for example.

In some examples, the production forecasting engine 132 can assess an impact of each scenario on overall production, and identify potential bottlenecks, which can be provided as part of the production forecast data 134. For example, the production forecasting engine 132 can run simulations for various production scenarios using the hydrocarbon network model 110, which can include normal operations, increased demand, equipment failures, scheduled maintenance, and/or unexpected disruptions to learn and/or understand how different factors impact flow of the hydrocarbon materials 120 with respect to (or in) the hydrocarbon network 114. During these simulations, the production forecasting engine 132 can evaluate a capacity of one or more components within the hydrocarbon network model 110 (e.g., pipelines, processing facilities, storage units, etc.) to handle expected production volumes. The production forecasting engine 132 can evaluate whether the one or more components are operating within defined design capacities or nearing design limits. The production forecasting engine 132 can analyze flow dynamics of hydrocarbons in the hydrocarbon network model 110 to identify any points where hydrocarbon flow can slow down or become restricted, which can happen due to insufficient pipeline capacity, limited processing capabilities, and/or inadequate storage space. For each identified bottleneck, the production forecasting engine 132 can assess its impact on overall production and supply chain and provide such data as part of the production forecast data 134. The production forecasting engine 132 can evaluate how the bottleneck affects an ability to meet production targets, manage inventories, and/or fulfill delivery schedules. In some examples, based on the identified bottlenecks, a contingency plan engine 140 can provide one or more recommendations as the contingency plan 142 for optimizing the hydrocarbon network 114. For example, the one or more recommendations can include rerouting flows, increasing capacity at certain facilities, scheduling maintenance more effectively, and/or investing in infrastructure upgrades.

The production forecasting engine 132 can be used to provide short-term, mid-term, and/or long-term hydrocarbon production forecasting, which can be provided as part of the production forecast data 134. Thus, the production forecast data 134 can include predictions or estimates of future hydrocarbon production across one or more stages of the hydrocarbon network 114. The production forecast data 134 can include different scenario results, such as outcomes of different production scenarios, for example, increased demand, equipment failures, regulatory changes, etc. The production forecast data 134 can in some instances also identify one or more potential bottlenecks in the hydrocarbon network 114.

To implement the production forecasting engine 132, the trainer 156 can be used to train the ML algorithm. The trainer 156 can use production forecasting training data. The production forecasting training data can include historical production rates, capturing daily, monthly, and yearly volumes of different hydrocarbon types such as crude oil, natural gas, and NGLs. In some examples, the production forecasting training data can include detailed operational parameters like flow rates, pressures, temperatures, equipment operational data, and processing capacities and efficiencies across various facilities. The production forecasting training data can include scheduled and unscheduled maintenance records to account for equipment downtime and performance. The production forecasting training data can include external factors such as market demand trends, regulatory changes, geopolitical events, and environmental conditions like weather data and natural disaster risks. In some examples, the production forecasting training data can include logistical and supply chain data detailing inventory levels, transportation methods, routes, distribution center capacities, and delivery schedules. The production forecasting training data can include detailed production methods, batch processing schedules, and efficiencies. The production forecasting training data can be split by the trainer 156 into training, validation, and test datasets. Supervised learning ML algorithms can be trained on the production forecasting training data, and techniques like cross-validation can be used to fine-tune the ML algorithm to provide the production forecasting engine 132. In some examples, the trainer 156 (or the production forecasting engine 132) can use real-time data and adaptive learning to continuously update the production forecasting engine 132 with new information, ensuring that the forecasts remain accurate and/or relevant.

In some examples, the simulation system 152 includes a demand forecasting engine 128 to predict future demand for the hydrocarbon materials 120 across the hydrocarbon network 114, such as production facilities, transportation infrastructure, distribution networks, and/or market regions. The demand forecasting engine 128 can utilize demand input data 160 and the hydrocarbon network model 110 to predict how much of the hydrocarbon materials 120 may be needed in a future across the hydrocarbon network 114. The demand input data 160 can include market demand trends, historical consumption patterns, and/or factors influencing consumer behavior such as, seasonal variations, economic indicators, and changes in market conditions. The demand input data 160 can include external factors, such as geopolitical events, regulatory changes, and environmental conditions that could affect market demand.

For example, the demand forecasting engine 128 can simulate scenarios using the hydrocarbon network model 110 based on the demand input data 160 to provide demand forecast data 138. These scenarios can include different levels of market demand growth or decline, regulatory changes, economic booms or recessions, and/or other external factors. The demand input data 160 can include projected demand levels (e.g., estimate of future demand for different hydrocarbon products (e.g., crude oil, natural gas, NGLs) over various timeframes, such as short-term, mid-term, and long-term forecasts), scenario outcomes (e.g., results from various simulated scenarios, including different levels of market demand growth or decline, regulatory changes, economic booms or recessions, and other external factors that could impact demand.), and/or one or more recommendations (e.g., suggested actions or strategies to address potential demand fluctuations, such as adjusting production levels, optimizing supply chain operations, or investing in infrastructure upgrades.)

To implement the demand forecasting engine 128, the trainer 156 can be used to train the ML algorithm. The trainer 156 can use demand forecasting training data. The demand forecasting training data can include historical market demand trends, consumption patterns (e.g., records of past consumption levels for various hydrocarbon products, including daily, monthly, and yearly volumes), factors influencing consumer behavior (e.g., seasonal variations, economic indicators (e.g., GDP growth rates, unemployment rates), and changes in market conditions that can impact consumer behavior and demand), and/or external factors (e.g., geopolitical events, regulatory changes, and environmental conditions (e.g., weather data, natural disaster risks) that could affect market demand. The demand forecasting training data can be split by the trainer 156 into training, validation, and test datasets. Supervised learning ML algorithms can be trained on the demand forecasting training data, and techniques like cross-validation can be used to fine-tune the ML algorithm to provide the demand forecasting engine 136. In some examples, the trainer 156 (or the demand forecasting engine 136) can use real-time data and adaptive learning to continuously update the demand forecasting engine 136 with new information, ensuring that the forecasts remain accurate and relevant.

In some examples, the tool 100 includes the contingency plan engine 140 to provide one or more contingency plans for responding to potential disruptions based on the demand forecast data 138, the production forecast data 134, and the disruption data 144. As an example, a contingency plan can identify an alternative production plant (or facility), for example, if there is a drop-in hydrocarbon production. The contingency plans can be continuously refined (or updated) as the contingency plan engine 140 receives updated demand forecast data, production forecast data and/or disruption data. Thus, if there any changes in the hydrocarbon network 114, the tool 100 can update appropriate contingency plans so that the contingency plans are up-to-date (or account for changes in the hydrocarbon network 114, which can include structural, process, and other types of changes (e.g., disruptions). The contingency plans can be stored in a contingency plan database 162. The contingency plan database 162 can store one or more contingency plans for responding to one or more potential disruptions that can occur in the hydrocarbon network 114.

For example, the contingency plan engine 140 can evaluate a connectivity of various facilities of the hydrocarbon network 114 across a same operational level to manage a disruption, such as the disruption 112. The contingency plan engine 140 can assess capacities, capabilities, and/or logistics of alternative production plants and determine a best option to shift production and maintain continuity in the hydrocarbon supply chain. The contingency plan engine 140 can quantify a production shortfall at a disrupted facility, including a type and volume of products affected using disruption data 144. The contingency plan engine 140 can assess an urgency of finding an alternative location based on a severity of the disruption and a priority of affected products, which can be identified by the demand forecast data 138. The contingency plan engine 140 can identify potential alternative facilities (or plants) that have enough capacity to handle additional production load. The contingency plan engine 140 can evaluate current utilization rates and available capacity based on the production forecast data 134 for potential alternative facilities. The contingency plan engine 140 can verify that the alternative facilities have necessary equipment, technology, and/or expertise.

In some examples, the contingency plan engine 140 can compare capacities and capabilities of the potential alternative plants using the following criteria: available capacity, production flexibility, and/or operational efficiency. The contingency plan engine 140 can calculate the available production capacity at each potential alternative facility based on current utilization rates from production forecast data for those potential alternative facilities. The contingency plan engine 140 can evaluate the flexibility of the potential alternative facilities to switch production processes or handle different types of products. The contingency plan engine 140 can assess an efficiency of the potential alternative facilities in terms of production speed, cost, and quality.

The contingency plan engine 140 can implement a linkage and feasibility analysis to provide a logistical feasibility, impact on supply chain, and risk assessment for each potential alternative facility. For example, the contingency plan engine 140 can evaluate logistics involved in shifting production to alternative plants, including transportation costs, time, and infrastructure. The contingency plan engine 140 can evaluate the potential impact on the overall supply chain, including raw material sourcing, intermediate processing stages, and final product distribution. The contingency plan engine 140 can consider risks associated with each alternative plant, such as the likelihood of further disruptions, regulatory compliance, and environmental factors using the disruption data 144.

Based on the comparison and feasibility analysis, the contingency plan engine 140 can identify one or more optimal (or best) alternative facilities of the potential alternative facilities. The contingency plan engine 140 can provide the contingency plan 142 for shifting production to the selected alternative facilities. The contingency plan 142 can include timelines, resource allocation, and any necessary adjustments to a production process of the hydrocarbon network 114.

In an example, referred to herein as a first example, when a refinery (facility), referred to as Refinery A, processing crude oil experiences an equipment failure, leading to a significant production drop of 50,000 barrels per day, the contingency plan engine 140 can be activated. The contingency plan engine 140 can process the production forecast data 134 to understand the capacities and utilization rates of nearby Refineries B and C. The demand forecast data 138 highlights a high demand for crude products, emphasizing an urgency to address the production shortfall swiftly. The disruption data provides detailed information on the nature and severity of the equipment failure at the disrupted refinery. Next, the contingency plan engine 140 can identify the disruption impact, quantifying the shortfall as 50,000 barrels per day and prioritizing the response due to the significant market demand and the severe production impact. Potential alternative plants are then identified by the contingency plan engine 140, revealing that Refinery B has an available capacity of 30,000 barrels per day, while Refinery C has an available capacity of 20,000 barrels per day. The contingency plan engine 140 can compare the capacities and capabilities of these refineries, confirming that both are capable of processing the crude oil. The contingency plan engine 140 determines that Refinery B has more flexibility to ramp up production quickly, as indicated by the production forecast data 134. The linkage and feasibility analysis and logistics assessment can indicate that transporting crude to Refinery B is more cost-effective due to its closer proximity. Furthermore, the supply chain analysis shows minimal impact on distribution routes for products processed at Refinery B. Based on this comprehensive analysis, the contingency plan engine 140 selects Refinery B and Refinery C as best alternative plants. The contingency plan engine 140 generates a production shift plan to move 30,000 barrels per day to Refinery B and 20,000 barrels per day to Refinery C, in some instances detailed logistics for transportation and resource reallocation to ensure a smooth transition and continued supply chain stability.

In some examples, the contingency plan engine 140 can detect a drop-in production capacity at a disrupted facility. The contingency plan engine 140 can determine the extent of the production drop at the disrupted facility. The contingency plan engine 140 can quantify the production shortfall in terms of specific products. The contingency plan engine 140 can receive user selections for potential alternative facilities. The contingency plan engine 140 can evaluate a capacity and capability of these potential alternative facilities to handle an additional production load. The contingency plan engine 140 can compare alternative potential alternative facilities based on an ability of these potential alternative facilities to accommodate the production shift. The contingency plan generator can identify best alternative facilities that can effectively take over the production without significant delays or additional disruptions.

In some examples, the contingency plan engine 140 can analyze supplementary systems associated with the production process (e.g., gas, NGL, water). The contingency plan engine 140 can assess how shifting production impacts these systems, considering a capacity and interdependencies of these systems. The contingency plan engine 140 can consider how shifting production to alternative plants will impact the supplementary systems and other products. For example, if AL crude production is shifted, the algorithm assesses how this shift affects the associated gas, NGL, and water systems. The contingency plan engine 140 can perform a vertical assessment to evaluate the interconnectedness of the supplementary systems and the overall impact on the hydrocarbon network 114. Based on the analysis, the contingency plan engine 140 can provide one or more recommendations of best alternative production plants, necessary adjustments to supplementary systems, and/or compensation strategies for affected products to maintain balance in the network.

In an example, referred to herein as a second example, when a refinery, referred to as Refinery A, processing crude oil experiences an equipment failure, it can result in a significant production drop of 50,000 barrels per day. To address this, the contingency plan engine 140 can determine an extent of the drop in production capacity. A user can then select two alternative refineries, Refinery B and Refinery C, as potential contingency locations. Through horizontal assessment, the contingency plan engine 140 compares the capacities of these refineries, identifying that Refinery B can handle an additional 30,000 barrels per day, while Refinery C can accommodate 20,000 barrels per day. Next, the contingency plan engine 140 conducts a supplementary systems analysis to assess the impact on the gas and water systems associated with crude oil processing at both refineries. The contingency plan engine 140 performs a vertical assessment to evaluate how shifting production affects the production of NGL and other by-products, identifying any other products that might be impacted and need compensation. Based on these analyses, the contingency plan engine 140 recommends shifting 30,000 barrels per day to Refinery B and 20,000 barrels per day to Refinery C. The contingency plan engine 140 can also advise adjusting the gas and water systems at both refineries to handle the increased load and identifies any production shortfalls in NGL and other by-products, recommending compensation measures to address these shortfalls.

In some examples, identifying the potential alternative plans, the contingency plan engine 140 can consider individual plant (facility) readiness (IPR) data 146. The IPR data 146 can be used to determine whether each potential alternative plan responsible for a certain produce is ready to compensate for a drop-in production by comparing pre-set operation data with actual plant process data. In some examples, the contingency plan engine 140 can consider switchover difficulty adjustment (SDA) data 154 in identifying the potential alternative facilities. The SDA data 154 can indicate a difficulty of switching operations from a first plant to a second plant for responding to one or more disruptions in the hydrocarbon network model. In some examples, the SDA data 154 can quantify a difficult with a value. Thus, the SDA data 154 can include switchover values indicative of switch over difficulties. The switchover values can be updated to reflect switchover challenges in the hydrocarbon network 114. For example, the contingency plan engine 140 can compute the switchover values. For example, to determine the switchover values for optimal plant selection, the contingency plant engine 140 can consider one or more factors. The contingency plant engine 140 can evaluate a proximity of an affected plant to a nearest operational plant to ensure quick response times. The contingency plant engine 140 can assess whether a single nearby plant can compensate for a production drop or if multiple plants are required to meet the demand. If two plants are necessary, the contingency plant engine 140 can analyze whether running a second nearest plant alone can fully compensate for the drop-off, thereby optimizing energy usage and potentially avoiding a need to operate multiple plants. Additionally, the contingency plant engine 140 can check the availability of the nearest swing facility, including the current storage capacity of available tanks, to ensure sufficient backup resources. These considerations ensure that the switchover process is both efficient and effective, maintaining production levels while minimizing energy consumption.

By way of example, a switch over value can be computed by the contingency plant engine 140 using expression:

$$SWV = {ω}_{1} \cdot D + {ω}_{2} \cdot C + {ω}_{3} \cdot E + {ω}_{4} \cdot A , \qquad ( 1 )$$

wherein SWV is a switchover value, D is the distance factor, representing the proximity of the affected plant to the nearest operational plant (or facility), C is the capacity factor, representing the ability of the nearby plant(s) to compensate for the production drop, E is the energy optimization factor, representing the efficiency of running the second nearest plant versus multiple plants, and A is the availability factor, representing the availability and capacity of the nearest swing facility and storage tanks, and ω₁, ω₂, ω₃, and ω₄ are weights assigned to each factor based on their relative importance.

The distance factor D can be computed by the contingency plant engine 140 using the following expression:

$$D = \frac{1}{Distance to nearest operational plant} . \qquad ( 2 )$$

The capacity factor C can be computed by the contingency plant engine 140 based on known capacity production capacity for the nearest operational plant (or facility)

The energy optimization factor E can be computed by the contingency plant engine 140 to evaluate an efficiency of running an additional plant using the following expression:

$$E = \frac{Energy required for running a second nearest plant}{Total energy consumption} . \qquad ( 3 )$$

The availability factor A can be computed by the contingency plant engine 140 to so that sufficient backup resources are available using the following expression:

$$A = \frac{Available storage capacity}{Required storage capacity} . \qquad ( 4 )$$

The contingency plan engine 140 can identify (or determine) if a particular switchover to a given potential alternative facility is challenging and proposes a next most suitable option, such as switch over to a different potential alternative facility based on the SDR data 154. For example, a large bore manual valve may need a substantial amount of time and manual intervention to close, and a faster alternative would be an actuated valve further away from the upset. Using the SDR data 154 ensures that a fastest course of action is identified and available. In some examples, the contingency plan engine 140 implements an error minimization function to verify process parameters are healthy and are within prescribed design ranges such as flow and pressure, to ensure erroneous isolations and impacts are not identified or utilized for contingency plan generation. In some examples, the contingency plan engine 140 can use an accuracy function to ensure that all data and outputs generated by one or more components of the tool 100 is within a predefined range, which can be referred to as a normal range.

In some examples, the tool 100 can receive a contingency plan request 164, which can be a request for a contingency plan for responding to the disruption 112. The contingency plan request 164 can characterize or indicate the disruption 112. Using the contingency plan request, the contingency plan engine 140 can identify one or more candidate contingency plans for the disruption 112. The contingency plan engine 140 can select one of the more candidate contingency plans as the contingency plan 142, in other examples, provide the one or more candidate contingency plans as the contingency plan 142.

The contingency plan 142 can be used to adjust one or more operations of the hydrocarbon network 114. For example, the contingency plan 142 can be used to implement a switchover of operations of the facility 122 to the facility 124 in response to the disruption 112. In some examples, a control system can use the contingency plan 142 to automatically adjust valves and/or other structural features of the hydrocarbon network 114 to reroute the hydrocarbon materials 120 to the facility 124 from the facility 122.

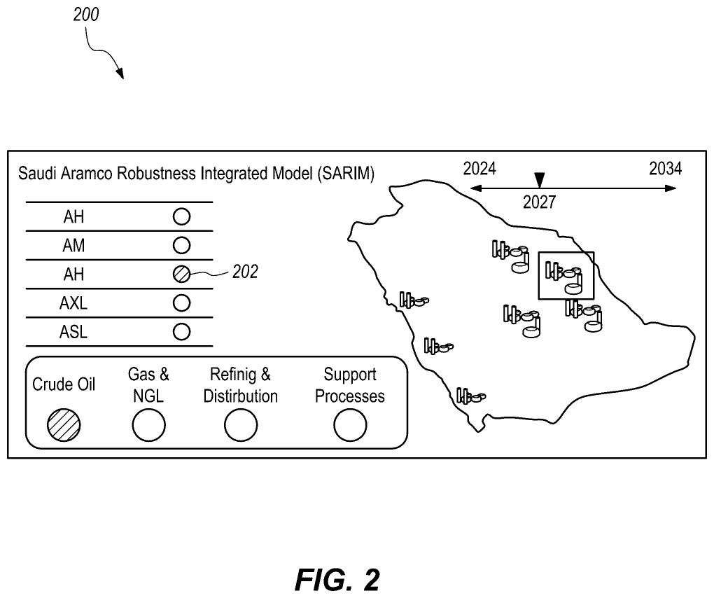

In some examples, the contingency plan engine 140 can include a graphical user interface (GUI) generator to provide an interactive GUI and dashboard for users to visualize an impact on any upset to the hydrocarbon network 114 and accordingly to the customers in addition to production and demand forecast. FIG. 2 is an example of an interactive GUI 200 that can be provided by the GUI generator. Thus, reference can be made to one or more examples of FIG. 1 in the example of FIG. 2. The interactive GUI 200 can be provided using commercially available software and integrated development environments such as Microsoft Excel and Microsoft Visual Studio. The interactive GUI 200 can include a country map with each facility identified therein, such as facilities AH, AM, AL, AXL, and ASL in Saudi Arabia. In the example of FIG. 2, the interactive GUI 200 identifies the facility AL (identified with reference numeral 202) as having a disruption in 2027. Accordingly, the tool 100 provides advantages over existing methods and systems, which typically rely on pre-defined contingency plans that simulate forecasts and determine available plants for production without addressing switchover difficulties and individual plant readiness. The traditional techniques often overlook current process parameters necessary to ensure readiness and minimize errors, such as flow and pressure inaccuracies, leading to potential human error and time delays in identifying the best course of action. The tool 100 enables a detailed, quantitative analysis of the robustness of an overall hydrocarbon chain network, providing dynamic assessment capabilities. Unlike traditional methods that rely on qualitative analysis, the tool 100 offers a data-driven, quantitative approach to robustness analysis. Continuous real-time data integration allows for ongoing assessment and updates, ensuring a network's readiness and resilience. By evaluating actual plant equipment conditions and reliability, the tool 100 determines the capability of the hydrocarbon network to withstand temporary upsets based on plant availability, plant equipment reliability, and performance conditions. The tool 100 can be used to minimize errors and ensures that the fastest and most effective contingency actions are identified and implemented. Accordingly, the tool 100 improves the accuracy, efficiency, and reliability of contingency planning and production forecasting in the hydrocarbon industry, thereby enhancing overall network resilience and operational performance.

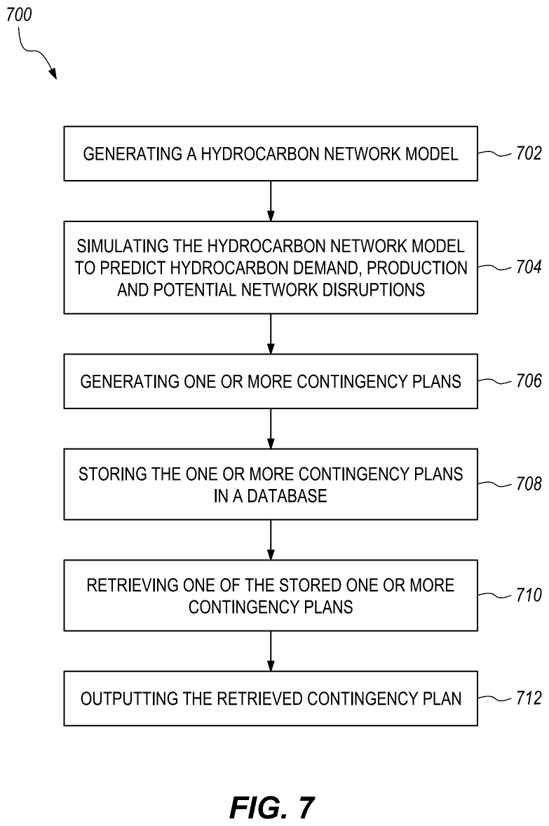

In view of the foregoing structural and functional features described above, an example method will be better appreciated with reference to FIG. 7. While, for purposes of simplicity of explanation, the example method of FIG. 7 is shown and described as executing serially, it is to be understood and appreciated that the present example is not limited by the illustrated order, as some actions could in other examples occur in different orders, multiple times and/or concurrently from that shown and disclosed herein. Moreover, it is not necessary that all described actions be performed to implement the method.

FIG. 7 is an example of a method 700 for generating a contingency plan, such as the contingency plan 142, as shown in FIG. 1. Thus, reference can be made to one or more examples of FIGS. 1-6 in the example of FIG. 7. The method 700 can be implemented by the tool 100, as shown in FIG. 1. The method 700 can begin at 702 with generating a hydrocarbon network model (e.g., the hydrocarbon network model 110, as shown in FIG. 1) representative of a hydrocarbon network (e.g., the hydrocarbon network 114, as shown in FIG. 1) comprising one or more plants (e.g., facilities 122-124, as shown in FIG. 1). At 704, the hydrocarbon network model can be simulated (e.g., by the simulation system 152, as shown in FIG. 1) to predict hydrocarbon demand, production, and potential disruptions for the hydrocarbon network. At 706, one or more contingency plans can be generated for responding to one or more disruptions in the hydrocarbon network model based on the predicted hydrocarbon demand, production, and potential disruptions, and a plant readiness of each of the one or more plants. At 708, the generated one or more contingency plans can be stored in a contingency plan database (e.g., the contingency plan database 162, as shown in FIG. 1). At 710, the one of the or more contingency plans (e.g., the contingency plan 142, as shown in FIG. 1) from the contingency plan database can be retrieved in response to a contingency plan request, the contingency plan request identifying a disruption in the hydrocarbon network. At 712, the retrieved contingency plan can be output to respond to the disruption in the hydrocarbon network.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

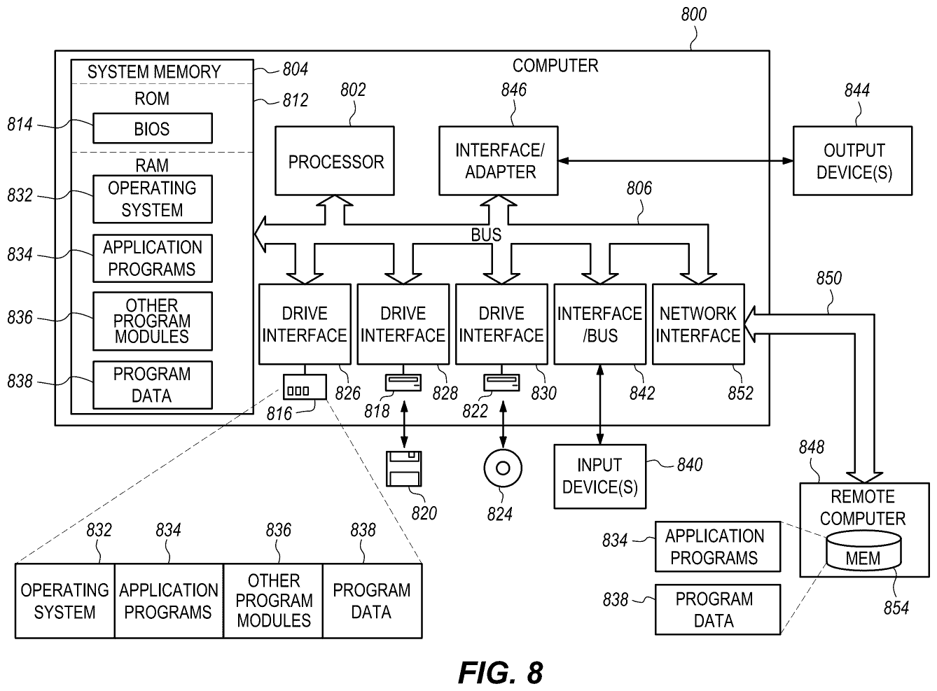

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 8. Thus, reference can be made to one or more examples of FIGS. 1-7 in the example of FIG. 8.

In this regard, FIG. 8 illustrates one example of a computer system 800 that can be employed to execute one or more embodiments of the present disclosure. Computer system 800 can be implemented on one or more general purpose networked computer systems, embedded computer systems, routers, switches, server devices, client devices, various intermediate devices/nodes or standalone computer systems. Additionally, computer system 800 can be implemented on various mobile clients such as, for example, a personal digital assistant (PDA), laptop computer, pager, and the like, provided it includes sufficient processing capabilities.

Computer system 800 includes processing unit 802, system memory 804, and system bus 806 that couples various system components, including the system memory 804, to processing unit 802. Dual microprocessors and other multi-processor architectures also can be used as processing unit 802. System bus 806 may be any of several types of bus structure including a memory bus or memory controller, a peripheral bus, and a local bus using any of a variety of bus architectures. System memory 804 includes read only memory (ROM) 810 and random access memory (RAM) 812. A basic input/output system (BIOS) 814 can reside in ROM 812 containing the basic routines that help to transfer information among elements within computer system 800.

Computer system 800 can include a hard disk drive 816, magnetic disk drive 818, e.g., to read from or write to removable disk 820, and an optical disk drive 822, e.g., for reading CD-ROM disk 824 or to read from or write to other optical media. Hard disk drive 816, magnetic disk drive 818, and optical disk drive 822 are connected to system bus 806 by a hard disk drive interface 826, a magnetic disk drive interface 828, and an optical drive interface 830, respectively. The drives and associated computer-readable media provide nonvolatile storage of data, data structures, and computer-executable instructions for computer system 800. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and disclosed herein. A number of program modules may be stored in drives and RAM 810, including operating system 832, one or more application programs 834, other program modules 836, and program data 838. In some examples, the application programs 834 can include one or more modules (or block diagrams), or systems, as shown and disclosed herein. Thus, in some examples, the application programs 834 can include the tool 100, as shown in FIG. 1.

A user may enter commands and information into computer system 800 through one or more input devices 840, such as a pointing device (e.g., a mouse, touch screen), keyboard, microphone, joystick, game pad, scanner, and the like. These and other input devices are often connected to processing unit 802 through a corresponding port interface 842 that is coupled to the system bus, but may be connected by other interfaces, such as a parallel port, serial port, or universal serial bus (USB). One or more output devices 844 (e.g., display, a monitor, printer, projector, or other type of displaying device) is also connected to system bus 806 via interface 846, such as a video adapter.

Computer system 800 may operate in a networked environment using logical connections to one or more remote computers, such as remote computer 848. Remote computer 848 may be a workstation, computer system, router, peer device, or other common network node, and typically includes many or all the elements described relative to computer system 800. The logical connections, schematically indicated at 850, can include a local area network (LAN) and a wide area network (WAN). When used in a LAN networking environment, computer system 800 can be connected to the local network through a network interface or adapter 852. When used in a WAN networking environment, computer system 800 can include a modem, or can be connected to a communications server on the LAN. The modem, which may be internal or external, can be connected to system bus 806 via an appropriate port interface. In a networked environment, application programs 834 or program data 838 depicted relative to computer system 800, or portions thereof, may be stored in a remote memory storage device 854.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

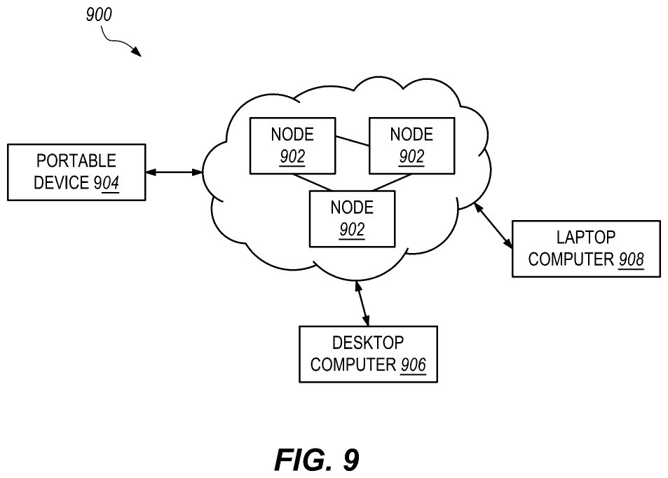

FIG. 9 is an example of a cloud computing environment 900 that can be used for implementing one or more modules and/or systems in accordance with one or more examples, as disclosed herein. Thus, reference can be made to one or more examples of FIGS. 1-8 in the example of FIG. 9. As shown, cloud computing environment 900 can include one or more cloud computing nodes 902 with which local computing devices used by cloud consumers (or users), such as, for example, personal digital assistant (PDA), cellular, or portable device 904, a desktop computer 906, and/or a laptop computer 908, may communicate. The computing nodes 902 can communicate with one another. In some examples, the computing nodes 902 can be grouped (not shown) physically or virtually, in one or more networks, such as Private, Community, Public, or Hybrid clouds, or a combination thereof. This allows the cloud computing environment 900 to offer infrastructure, platforms and/or software as services for which a cloud consumer does not need to maintain resources on a local computing device. The devices 904-908, as shown in FIG. 9, are intended to be illustrative and that computing nodes 902 and cloud computing environment 900 can communicate with any type of computerized device over any type of network and/or network addressable connection (e.g., using a web browser). In some examples, the one or more computing nodes 902 are used for implementing one or more examples disclosed herein relating to root-source identification. Thus, in some examples, the one or more computing nodes can be used to implement modules, platforms, and/or systems, as disclosed herein.

In some examples, the cloud computing environment 900 can provide one or more functional abstraction layers. It is to be understood that the cloud computing environment 900 need not provide all of the one or more functional abstraction layers (and corresponding functions and/or components), as disclosed herein. For example, the cloud computing environment 900 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 900 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 900 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 900, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 900 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 900 can provide a workloads layer that provides examples of functionality for which the cloud computing environment 900 may be utilized. Examples of workloads and functions which may be provided from this layer include: mapping and navigation; software development and lifecycle management; virtual classroom education delivery; data analytics processing; and transaction processing. Various embodiments of the present disclosure can utilize the cloud computing environment 900.

The present disclosure is also directed to the following exemplary embodiments, which can be practiced in any combination thereof:

Embodiment A: a computer-implemented method comprising: generating a hydrocarbon network model representative of a hydrocarbon network comprising one or more plants; simulating the hydrocarbon network model to predict hydrocarbon demand, production, and potential disruptions for the hydrocarbon network; generating one or more contingency plans for responding to one or more disruptions in the hydrocarbon network model based on the predicted hydrocarbon demand, production, and potential disruptions, and a plant readiness of each of the one or more plants; storing the generated one or more contingency plans in a contingency plan database; retrieving one of the or more contingency plans from the contingency plan database in response to a contingency plan request, the contingency plan request identifying a disruption in the hydrocarbon network; and outputting the retrieved contingency plan to respond to the disruption in the hydrocarbon network.

Embodiment B: a system comprising: memory to store machine-readable instructions; one or more processors to access the memory and execute the machine-readable instructions, the machine-readable instructions comprising: a simulation system configured to simulate a hydrocarbon network model to predict hydrocarbon demand, production, and potential disruptions for a hydrocarbon network comprising one or more plants; a contingency plan engine configured to generate one or more contingency plans for responding to one or more disruptions in the hydrocarbon network model based on the predicted hydrocarbon demand, production, and potential disruptions, a plant readiness of each of the one or more plants, and SDA data, the SDA data identify a difficulty of switching operations from a first plant to a second plant of the one or more plants for responding to one or more disruptions in the hydrocarbon network model; identifying one of the more contingency plans for responding to a disruption in the hydrocarbon network; and outputting the identified contingency plan to a device to respond to the disruption in the hydrogen carbon network.

Embodiment C: a system comprising: one or more computing platforms configured to: generate a hydrocarbon network model representative of a hydrocarbon network comprising one or more plants; simulate the hydrocarbon network model to predict hydrocarbon demand, production, and potential disruptions for the hydrocarbon network; generate one or more contingency plans for responding to one or more disruptions in the hydrocarbon network model based on the predicted hydrocarbon demand, production, and potential disruptions, and a plant readiness of each of the one or more plants; store the generated one or more contingency plans in a contingency plan database; retrieve one of the or more contingency plans from the contingency plan database in response to a contingency plan request, the contingency plan request identifying a disruption in the hydrogen carbon network; and output the retrieved contingency plan to respond to the disruption in the hydrogen carbon network.

Each of embodiments A through C may have one or more of the following additional elements in any combination: Embodiment 1: wherein the simulating comprises predicting different types of disruptions using the hydrocarbon network model to provide the potential disruptions for the hydrocarbon network; Embodiment 2: wherein the hydrocarbon network model is simulated for the different types of disruptions using an ML model; Embodiment 3: wherein the ML model is trained based on disruption training data, the disruption training data comprising one or more of historical disruption data, monitoring data, operational data, and environmental data; Embodiment 4: wherein the predicting of the different types of disruptions is based on disruption input data, the disruption input data comprising one or more of historical disruption data, monitoring data, operational data, and environmental data; Embodiment 5: wherein the simulating further comprises predicting future hydrocarbon output across one or more stages of the hydrocarbon network to provide the predicted production; Embodiment 6: wherein an ML model is used for predicting the future hydrocarbon output; Embodiment 7: wherein the ML model is trained based on one or more historical production rates, capturing daily, monthly, and yearly volumes of different hydrocarbon types, operational parameters, equipment operational data, processing capacities and efficiencies across various facilities of the hydrocarbon network, scheduled and unscheduled maintenance records, market demand trends, regulatory changes, geopolitical events, and environmental conditions, logistical and supply chain data, production methods, and batch processing schedules; Embodiment 8: wherein the predicting the future hydrocarbon output is based on production input data, the production input data comprising one or more of historical production volumes, operational parameters, equipment operational data, processing capacities and efficiencies across various facilities of the hydrocarbon network, schedule and unscheduled maintenance records, market demand trends, regulatory changes, geopolitical events, environmental conditions, logistical and supply chain data, and disruption data; Embodiment 9: wherein the simulating further comprises predicting future hydrocarbon demand for one or more production facilities, transportation infrastructure, and distribution networks of the hydrocarbon network to provide the predicted hydrocarbon demand; Embodiment 10: wherein an ML model is used for predicting the future hydrocarbon demand; Embodiment 11: wherein the ML model is trained based on demand forecasting data, the demand forecasting data comprising one or more historical market demand trends, consumption patterns, factors influencing consumer behavior, and geopolitical events, regulatory changes, and environmental conditions; Embodiment 12: wherein the predicting the future hydrocarbon demand is based on demand input data, the demand input data comprising one or more of market demand trends, historical consumption patterns, factors influencing consumer behavior, geopolitical events, regulatory changes, and environmental conditions; Embodiment 13: wherein the generating the one or more contingency plans is further based on SDA data, the SDA data identify a difficulty of switching operations from a first plant to a second plant for responding to one or more disruptions in the hydrocarbon network model; Embodiment 14: wherein the machine-readable instructions further comprise a model generator configured to generate the hydrocarbon network model based on model data, the model data representing one or more plants of the hydrocarbon network at a micro- and macro-level of detail; Embodiment 15: wherein the simulation system comprises: a first ML model that is trained to predict different types of disruptions using the hydrocarbon network model to provide the potential disruptions for the hydrocarbon network, a second ML model that is trained to predict future hydrocarbon output across one or more stages of the hydrocarbon network to provide the predicted production for the hydrocarbon network; and a third ML model that is trained to predict future hydrocarbon demand for one or more production facilities, transportation infrastructure, and distribution networks of the hydrocarbon network to provide the predicted hydrocarbon demand; Embodiment 16: wherein the generating the one or more contingency plans is further based on SDA data, the SDA data identify a difficulty of switching operations from a first plant to a second plant for responding to one or more disruptions in the hydrocarbon network model; and Embodiment 17: wherein the disruption is at the first plant, and wherein the contingency plan, or a portion of the contingency plan is used to adjust at least one one or more valves of the hydrocarbon network to switch operations from the first plant to the second plant.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 5-10% of the indicated number.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

1. A computer-implemented method comprising:
generating a hydrocarbon network model representative of a hydrocarbon network comprising one or more plants;
simulating the hydrocarbon network model to predict hydrocarbon demand, production, and potential disruptions for the hydrocarbon network;
generating one or more contingency plans for responding to one or more disruptions in the hydrocarbon network model based on the predicted hydrocarbon demand, production, and potential disruptions, and a plant readiness of each of the one or more plants;
storing the generated one or more contingency plans in a contingency plan database;
retrieving one of the or more contingency plans from the contingency plan database in response to a contingency plan request, the contingency plan request identifying a disruption in the hydrocarbon network; and
outputting the retrieved contingency plan to respond to the disruption in the hydrocarbon network.

2. The computer-implemented method of claim 1, wherein the simulating comprises predicting different types of disruptions using the hydrocarbon network model to provide the potential disruptions for the hydrocarbon network.

3. The computer-implemented method of claim 2, wherein the hydrocarbon network model is simulated for the different types of disruptions using a machine learning (ML) model.

4. The computer-implemented method of claim 3, wherein the ML model is trained based on disruption training data, the disruption training data comprising one or more of historical disruption data, monitoring data, operational data, and environmental data.

5. The computer-implemented method of claim 2, wherein the predicting of the different types of disruptions is based on disruption input data, the disruption input data comprising one or more of historical disruption data, monitoring data, operational data, and environmental data.

6. The computer-implemented method of claim 2, wherein the simulating further comprises predicting future hydrocarbon output across one or more stages of the hydrocarbon network to provide the predicted production.

7. The computer-implemented method of claim 6, wherein a machine learning (ML) model is used for predicting the future hydrocarbon output.

8. The computer-implemented method of claim 7, wherein the ML model is trained based on one or more historical production rates, capturing daily, monthly, and yearly volumes of different hydrocarbon types, operational parameters, equipment operational data, processing capacities and efficiencies across various facilities of the hydrocarbon network, scheduled and unscheduled maintenance records, market demand trends, regulatory changes, geopolitical events, and environmental conditions, logistical and supply chain data, production methods, and batch processing schedules.

9. The computer-implemented method of claim 6, wherein the predicting the future hydrocarbon output is based on production input data, the production input data comprising one or more of historical production volumes, operational parameters, equipment operational data, processing capacities and efficiencies across various facilities of the hydrocarbon network, schedule and unscheduled maintenance records, market demand trends, regulatory changes, geopolitical events, environmental conditions, logistical and supply chain data, and disruption data.

10. The computer-implemented method of claim 6, wherein the simulating further comprises predicting future hydrocarbon demand for one or more production facilities, transportation infrastructure, and distribution networks of the hydrocarbon network to provide the predicted hydrocarbon demand.

11. The computer-implemented method of claim 10, wherein a machine learning (ML) model is used for predicting the future hydrocarbon demand.

12. The computer-implemented method of claim 11, wherein the ML model is trained based on demand forecasting data, the demand forecasting data comprising one or more historical market demand trends, consumption patterns, factors influencing consumer behavior, and geopolitical events, regulatory changes, and environmental conditions.

13. The computer-implemented method of claim 10, wherein the predicting the future hydrocarbon demand is based on demand input data, the demand input data comprising one or more of market demand trends, historical consumption patterns, factors influencing consumer behavior, geopolitical events, regulatory changes, and environmental conditions.

14. The computer-implemented method of claim 1, wherein the generating the one or more contingency plans is further based on switchover difficulty adjustment (SDA) data, the SDA data indicating a difficulty of switching operations from a first plant to a second plant for responding to one or more disruptions in the hydrocarbon network model.

15. A system comprising:
memory to store machine-readable instructions;
one or more processors to access the memory and execute the machine-readable instructions, the machine-readable instructions comprising:
a simulation system configured to simulate a hydrocarbon network model to predict hydrocarbon demand, production, and potential disruptions for a hydrocarbon network comprising one or more plants;
a contingency plan engine configured to:
generate one or more contingency plans for responding to one or more disruptions in the hydrocarbon network model based on the predicted hydrocarbon demand, production, and potential disruptions, a plant readiness of each of the one or more plants, and switchover difficulty adjustment (SDA) data, the SDA data indicating a difficulty of switching operations from a first plant to a second plant of the one or more plants for responding to one or more disruptions in the hydrocarbon network model;
identify one of the more contingency plans for responding to a disruption in the hydrocarbon network; and
output the identified contingency plan to a device to respond to the disruption in the hydrogen carbon network.

16. The system of claim 14, wherein the machine-readable instructions further comprise a model generator configured to generate the hydrocarbon network model based on model data, the model data representing one or more plants of the hydrocarbon network at a micro- and macro-level of detail.

17. The system of claim 15, wherein the simulation system comprises:
a first machine-learning (ML) model that is trained to predict different types of disruptions using the hydrocarbon network model to provide the potential disruptions for the hydrocarbon network;
a second ML model that is trained to predict future hydrocarbon output across one or more stages of the hydrocarbon network to provide the predicted production for the hydrocarbon network; and
a third ML model that is trained to predict future hydrocarbon demand for one or more production facilities, transportation infrastructure, and distribution networks of the hydrocarbon network to provide the predicted hydrocarbon demand.

18. A system comprising:
one or more computing platforms configured to:
generate a hydrocarbon network model representative of a hydrocarbon network comprising one or more plants;
simulate the hydrocarbon network model to predict hydrocarbon demand, production, and potential disruptions for the hydrocarbon network;
generate one or more contingency plans for responding to one or more disruptions in the hydrocarbon network model based on the predicted hydrocarbon demand, production, and potential disruptions, and a plant readiness of each of the one or more plants;
store the generated one or more contingency plans in a contingency plan database;
retrieve one of the or more contingency plans from the contingency plan database in response to a contingency plan request, the contingency plan request identifying a disruption in the hydrogen carbon network; and
output the retrieved contingency plan to respond to the disruption in the hydrogen carbon network.

19. The system of claim 18, wherein the generating the one or more contingency plans is further based on switchover difficulty adjustment (SDA) data, the SDA data indicating a difficulty of switching operations from a first plant to a second plant for responding to one or more disruptions in the hydrocarbon network model.

20. The system of claim 19, wherein the disruption is at the first plant, and wherein the contingency plan, or a portion of the contingency plan is used to adjust at least one or more valves of the hydrocarbon network to switch operations from the first plant to the second plant.
